(19) United States
(12) Patent Application Publication
(10) Pub. No.: US 2024/0089926 A1
(43) Pub. Date: Mar. 14, 2024

(54) SIDELINK RESOURCE SELECTION BASED ON PREDEFINED SET

(71) Applicant: MediaTek Singapore Pte. Ltd., Singapore (SG)

(72) Inventor: Ahmet Umut UGURLU, Cambridge (GB)

(21) Appl. No.: 18/553,753

(22) PCT Filed: Apr. 8, 2022
(86) PCT No.: PCT/CN2022/085818

§ 371 Date: Oct. 3, 2023

Related U.S. Application Data
(60) Provisional application No. 63/172,122, filed on Apr. 8, 2021.

(51) Int. Cl. H04W 72/02; H04W 28/26; H04W 72/40

(52) U.S. Cl. CPC H04W 72/02; H04W 28/26; H04W 72/40

(57) ABSTRACT

Various examples and schemes pertaining to sidelink resource selection based on a predefined set for vehicle-to-everything (V2X) in 5^{th} Generation (5G) New Radio (NR) mobile communications are described. An apparatus implemented in a user equipment (UE) performs a first type of sensing on a sidelink during a first sensing window to select first resources from a first set of candidate resources within a selection window. The apparatus performs a second type of sensing on the sidelink during a second sensing window to select second resources from a second set of candidate resources within the selection window. The apparatus then communicates with another UE on the sidelink using at least the selected second resources from the second set of candidate resources. The first type of sensing and the second type of sensing may be different from each other. The second set may at least partially overlap with the first set.

### CROSS REFERENCE TO RELATED PATENT APPLICATION(S)

The present disclosure is part of a non-provisional application claiming the priority benefit of U.S. Patent Application No. 63/172,122, filed on 8 Apr. 2021, the content of which being incorporated by reference in its entirety.

### TECHNICAL FIELD

The present disclosure is generally related to wireless communications and, more particularly, to techniques pertaining to sidelink resource selection by a user equipment (UE) based on a predefined set for vehicle-to-everything (V2X) in 5^{th} Generation (5G) New Radio (NR) mobile communications.

### BACKGROUND

Unless otherwise indicated herein, approaches described in this section are not prior art to the claims listed below and are not admitted as prior art by inclusion in this section.

In V2X communications under the 3^{rd} Generation Partnership Project (3GPP) specifications, UEs that are in a close proximity can directly communicate with each other by exchanging packets in sidelink. A UE that is to transmit a packet in sidelink needs to choose or determine a set of physical radio resources (e.g., time and frequency resources) from a resource pool. Firstly, the transmitting UE performs a sensing procedure to determine the set of resources. After sensing, the selected resources are reserved. Then, the packet is transmitted on those reserved resources. The purpose of sensing is to detect resource reservation made by other UE(s).

In sidelink, allocation of physical radio resources can be either controlled by a centralized scheduler or by each device/UE separately. In case of a centralized scheduler, either a special type of network node (e.g., base station, eNB or gNB) or one of the available devices/UEs can be assigned the role to manage and control scheduling of resources for a group of devices/UEs. In case of decentralized resource allocation, each transmitting device/UE or each receiving device/UE can select some of the preferred physical radio resources prior to transmission. Such independent resource selection requires a sensing procedure to be performed to detect and identify potential physical radio resources that are already intended to be used by other devices/UEs in the vicinity. This type of sensing operation typically requires continuous monitoring and decoding of all likely physical radio resources that can be reserved in a sidelink resource pool, and such sensing operation is used in 5G cellular operations for sidelink.

However, continuous monitoring of all potential sidelink resources tend to require an exhaustive sensing procedure, thereby leading to considerable power consumption for a device/UE. Long-Term Evolution (LTE) sidelink operation generally uses a partial sensing approach to overcome such issue of power consumption. As LTE sidelink mostly uses periodic traffic patterns, partial sensing design follows an intermittent monitoring schedule of sidelink resources with a periodicity that overlaps with the periodicity of expected packet transmission occasions. A similar partial sensing approach could also be considered for 5G cellular systems. Nevertheless, unlink LTE, 5G sidelink may support the use of both periodic and aperiodic packet transmissions in a resource pool. Since the availability of an aperiodic packet cannot be predicted beforehand based on some known periodicity, aligning the intermittent sensing occasions with the transmission time of an aperiodic traffic would be cumbersome. Therefore, there is a need for a solution of detecting periodic reservation indications when a power-limited UE is to transmit an aperiodic packet.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

The present disclosure aims to propose concepts, solutions, schemes, techniques, designs, methods and apparatus pertaining to sidelink resource selection based on a predefined set for V2X in 5G NR mobile communications. It is believed that implementations of various proposed schemes described herein may address or otherwise alleviate aforementioned issues. For instance, by implementing one or more of the proposed schemes in sidelink resource selection, a power-limited device/UE may perform packet transmission in a resource pool that is shared by multiple devices/UEs. Advantageously, the proposed schemes may optimize power consumption of the device/UE by reducing the amount of physical radio resources that need to be monitored or otherwise sensed by a device/UE prior to packet transmission. Moreover, the proposed schemes may optimize transmission reliability by minimizing the probability of packet collisions among aperiodic and periodic traffic sources each of which originating from one or more other devices/UEs.

In one aspect, a method may involve a processor of an apparatus, implemented in a UE, performing a first type of sensing on a sidelink during a first sensing window to select first resources from a first set of candidate resources within a selection window. The method may also involve the processor performing a second type of sensing on the sidelink during a second sensing window to select second resources from a second set of candidate resources within the selection window. The method may further involve the processor communicating with another UE on the sidelink using at least the selected second resources from the second set of candidate resources. The first type of sensing and the second type of sensing may be different from each other. The second set of candidate resources may at least partially overlap with the first set of candidate resources.

It is noteworthy that, although description provided herein may be in the context of certain radio access technologies, networks and network topologies such as NR V2X, the proposed concepts, schemes and any variation(s)/derivative(s) thereof may be implemented in, for and by other types of radio access technologies, networks and network topologies such as, for example and without limitation, 5^{th} Generation (5G), Long-Term Evolution (LTE), LTE-Advanced, LTE-Advanced Pro and any future-developed networks and technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example scenario under a proposed scheme in accordance with the present disclosure.

FIG. 4 is a diagram of an example scenario under a proposed scheme in accordance with the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

Overview

Implementations in accordance with the present disclosure relate to various techniques, methods, schemes and/or solutions pertaining to sidelink resource selection based on a predefined set for V2X in 5G NR mobile communications. According to the present disclosure, a number of possible solutions may be implemented separately or jointly. That is, although these possible solutions may be described below separately, two or more of these possible solutions may be implemented in one combination or another.

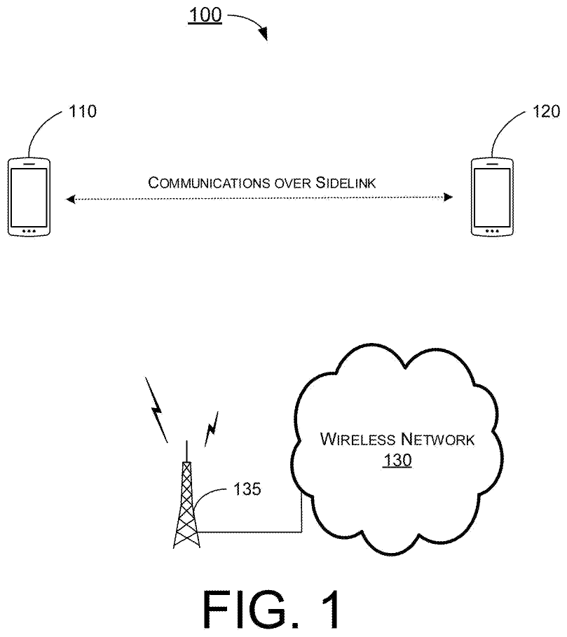

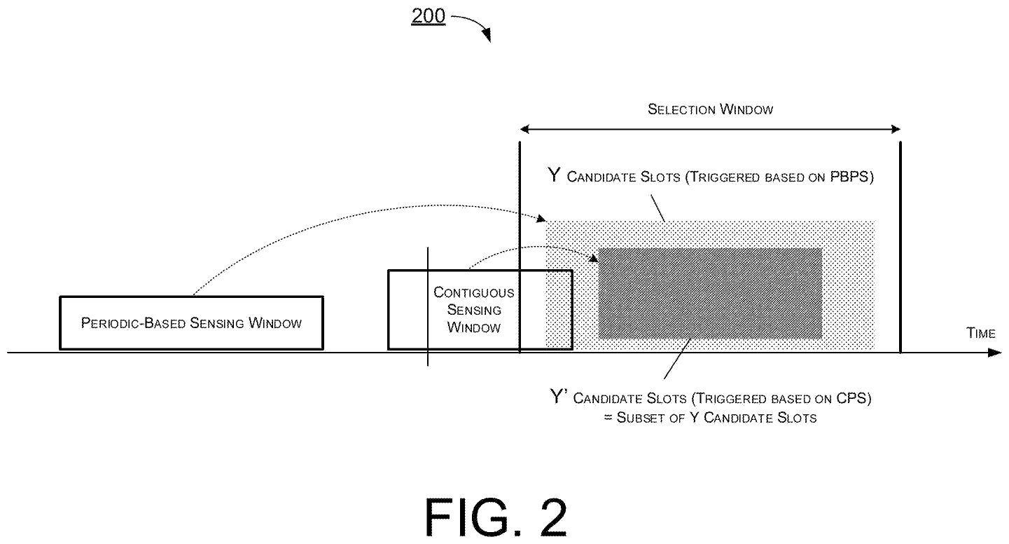

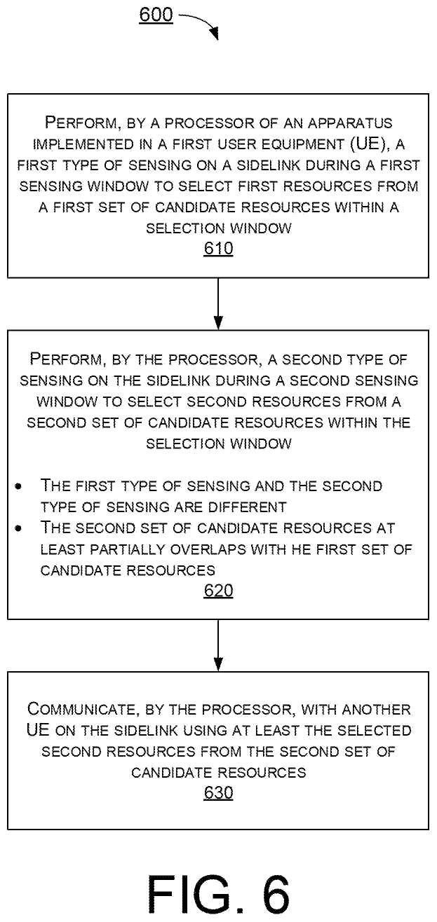

FIG. 1 illustrates an example network environment 100 in which various solutions and schemes in accordance with the present disclosure may be implemented. FIG. 2˜FIG. 6 illustrate examples of implementation of various proposed schemes in network environment 100 in accordance with the present disclosure. The following description of various proposed schemes is provided with reference to FIG. 1˜FIG. 6. Referring to FIG. 1, network environment 100 may involve at least a first UE 110, a second UE 120 and a wireless network 130. Wireless network 130 may be in wireless communication with first UE 110 and/or second UE 120 via a network node 135 (e.g., a base station, eNB, gNB or transmit/receive point (TRP)), and first UE 110 may be in wireless communication with second UE 120 via a sidelink. Each of first UE 110 and second UE 120 may be in or as a part of, for example and without limitation, a portable apparatus (e.g., smartphone), a vehicle or a component thereof, a roadside unit (RSU) (e.g., a traffic signal, a street lamp, a roadside sensor or a roadside structure) or an Internet of Thing (IoT) device (e.g., a sensor). In network environment 100, first UE 110, second UE 120 and wireless network 130 (via network node 135) may implement various schemes pertaining to sidelink resource selection based on a predefined set for V2X in 5G NR mobile communications in accordance with the present disclosure, as described below.

An in-coverage or out-of-coverage UE (e.g., UE 110 and/or UE 120) can manage its own resource selection in a mode-2 operation when performing a packet transmission in a 5G NR sidelink. The mode-2 operation involves a sensing procedure in which available sidelink resources are monitored for any sidelink control information (SCI) transmitted from other UEs. Such monitoring aids UE 110 and UE 120 in predicting whether certain sidelink resources are likely to be occupied by other transmissions in the next time slots. On the other hand, sensing can be performed on a limited set (or subset) of resources to minimize power consumption. In such circumstances, the subset of resources on which sensing is performed may be aligned with the availability in time of the UE's own packet transmission. The arrival time of a periodic traffic may be predicted beforehand according to the expected packet periodicity.

In case of aperiodic packet transmissions, prediction of packet transmission timing is not as straight forward. In case that alignment of sensing time occasions and packet transmission timing cannot be guaranteed, the UE (e.g., UE 110 and/or UE 120) may need to perform sensing continuously on a larger set of resources, thereby resulting in higher power consumption. Thus, under various proposed schemes in accordance with the present disclosure, a power-limited UE (e.g., UE 110 and/or UE 120) may detect periodic resource reservations when performing resource selection for packet transmission.

In general, different types of sensing may be performed depending on the situation. On one hand, UEs that are not power-limited may perform full sensing on a sidelink in that sensing is performed on every slot within a given sensing window. On the other hand, to minimize power consumption, UEs that are power-limited may perform partial sensing on the sidelink in that sensing is performed on one or more slots but not all slots within the sensing window. Regarding partial sensing, there are two kinds, namely: periodic-based partial sensing (PBPS) and contiguous partial sensing (CPS). PBPS supports detection of periodic reservations by one or more other UEs when a UE is transmitting a periodic traffic. CPS supports detection of aperiodic reservations by one or more other UEs when the UE is transmitting a periodic traffic, and CPS also supports detection of aperiodic reservations by one or more other UEs when the UE is transmitting an aperiodic traffic. Accordingly, a UE (e.g., UE 110 and/or UE 120) may perform different types of partial sensing depending on the circumstances at the time when the UE has packets/traffic for transmission (e.g., based on its traffic type and network pre-configuration). For example, when transmitting a periodic traffic, the UE may perform PBPS. When transmitting an aperiodic traffic, the UE may perform CPS plus PBPS in case that periodic reservations in the resource pool are allowed (for all UEs). Alternatively, the UE may perform CPS in case that periodic reservations in the resource pool are not allowed. However, current sensing methods are not suitable for detection of periodic reservations when the UE is transmitting an aperiodic traffic (e.g., when P_{rsvp_tx}=0).

FIG. 2 illustrates an example scenario 200 under a proposed scheme in accordance with the present disclosure. To address aforementioned issue with miss-detection with periodic reservations (when P_{rsvp_tx}=0), the concept of predefined windowing in the time domain may be introduced such that a predefined resource selection window may be utilized periodically for aperiodic traffic transmission. The predefined resource selectin window may be pre-configured by wireless network 130 via network node 135. Referring to FIG. 2, when transmitting aperiodic packets with periodic reservations enabled or otherwise allowed, a UE (e.g., UE 110 or UE 120) may perform PBPS on a sidelink during a periodic-based sensing window to select a set of Y candidate slots (triggered based on the PBPS process) in a selection window. The UE may also perform CPS on the sidelink during a contiguous sensing window to select another set of Y′ candidate slots (triggered based on the CPS process) in the selection window. The selected Y′ candidate slots may then be utilized by the UE in transmitting aperiodic packets. As can be seen, under the proposed scheme, the selected set of Y′ candidate slots (as a result of the CPS) may be a subset of the selected set of Y candidate slots (as a result of the PBPS).

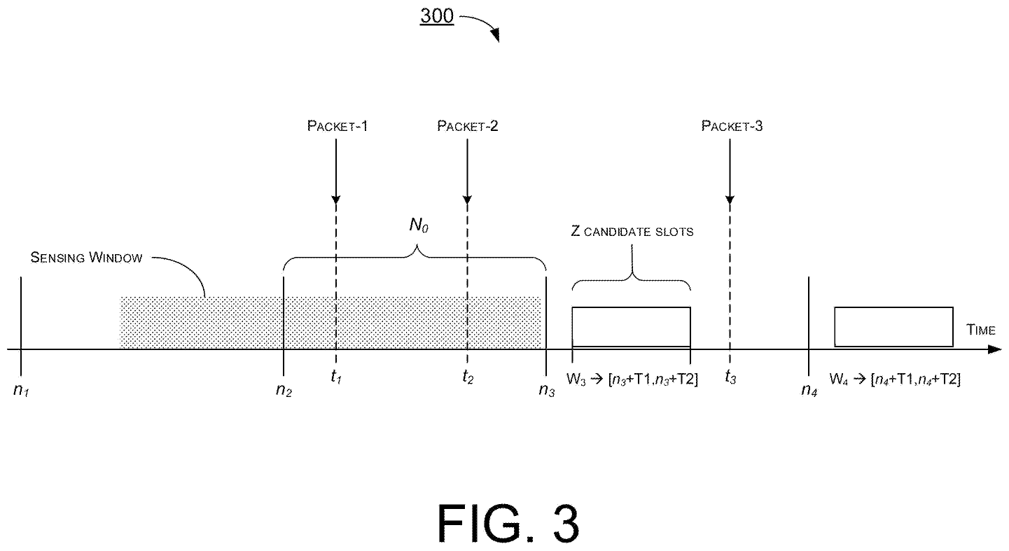

FIG. 3 illustrates an example scenario 300 under a proposed scheme in accordance with the present disclosure. Referring to FIG. 3, a UE (e.g., UE 110 or UE 120) may define a list of periodic windows in time for aperiodic packet arrivals, for which resources may be selected from a subsequent set of Z candidate slots. Any aperiodic traffic that arrives at higher layers between [nₖ, nₖ₊₁] may be transmitted on a subset of the Z candidate slots in the predefined window Wₖ₊₁. For instance, assuming that an aperiodic packet-1 arrives at a higher layer at time t₁ and another packet-2 arrives at time t₂, as these packets become available for transmission during the time interval [n₂, n₃], resource selection may be performed in window W₃=[n₃+T1, n₃+T2]. Another aperiodic packet-3 that becomes available for transmission at time t3 may be transmitted on resources from the subset of candidate slots from window W₄=[n₄+T1, n₄+T2].

Under the proposed scheme, it may be required that (N₀+Z) is less than a remaining packet delay budget (PDB). The PDB may denote the remaining packet delay budget that is necessary to guarantee that the minimum packet latency requirement is fulfilled. The parameter Z may denote the number of candidate slots in the resource selection (or re-selection) window or in the selected subset of candidate slots. The parameter N₀ may denote the predefined window size to determine which aperiodic packets are allowed for transmission.

Under the proposed scheme, one or more of several design approaches or options may be utilized. Ina first option (Option-1), fixed windowing may be utilized in which N₀ may be defined as a fixed value. In a second option (Option-2), adaptive windowing may be utilized to adjust the window size. In particular, in Option-2a, adaptive windowing may be based on a single session priority. Alternatively, in Option-2b, adaptive windowing may be based on two or more session priorities. In a third option (Option-3), full adaptive windowing may be utilized where any subsequent packet arrival windows may have a different size. Each of these options is further described below.

In Option-1, which is about fixed windowing where N₀ is defined as a fixed value, predefined windows [nₖ, nₖ₊₁] for all k=1, 2, 3, . . . may have a fixed duration of N₀. This option may be useful when a UE (e.g., UE 110 or UE 120) may be configured with one service type only for each resource pool. Alternatively, the UE may be expected to transmit packets with different service priorities with the same fixed predefined window size of N₀. In such cases, the power saving gain, system reliability and latency performance may be limited.

In Option-2a, which is about adaptive windowing based on a single session priority, a UE (e.g., UE 110 or UE 120) may be configured with a session priority by reporting from the UE's own higher layer to its physical (PHY) layer. For instance, a medium access control (MAC) layer may trigger a switch to a different session priority, which may be associated with a different N₀ window size. In this option, the time interval in [nₖ, nₖ₊₁] may be dynamically changed. However, only one time interval may be configured at any given time.

In Option-2b, which is about adaptive windowing based on two or more session priorities, higher layers may report multiple session priorities to the PHY layer. Then, when a new resource (re)-selection is triggered at the PHY layer, the triggering indication may carry session priority information. Depending on the priority information, the UE may use the available sensing information that corresponds to the indicated session priority information in the trigger.

In Option-3, which is about full adaptive windowing where any subsequent packet arrival window may have a different size than that of previous packet arrival windows, a UE (e.g., UE 110 or UE 120) may be preconfigured with a set of session priorities. The UE may perform sensing according to all N₀ window sizes that correspond to at least one of the preconfigured session priorities. After a resource (re)-selection is triggered, the UE may proceed with resource selection according to a predefined window pattern that corresponds to the session priority of the transmission block (TB).

It is noteworthy that, in each of above-described Option-1, Option-2a, Option-2b and Option-3, the term “session priority” may refer to any one or any combination of two or more of the following: PC5 interface 5G NR Standardized quality of service (QoS) Identifier (PQI) from a 5^{th} Generation Core (5GC), QoS flow indicator (QFI) in the Service Data Adaption Protocol (SDAP), packet priority in PHY, and one or more of ongoing QFIs.

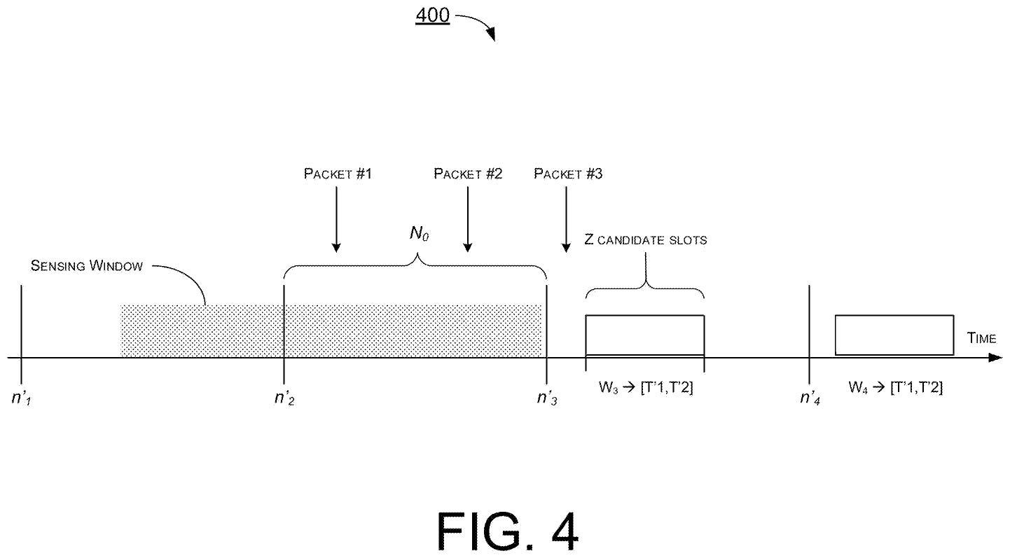

In summary, under various proposed schemes in accordance with the present disclosure, the concept of predefined windowing in the time domain may be introduced and utilized to enable a UE (e.g., UE 110 and/or UE 120) to detect periodic reservations in a sidelink resource pool when the UE is transmitting an aperiodic traffic. FIG. 4 illustrates an example scenario 400 in which the various proposed schemes may be implemented. Referring to FIG. 4, each predefined packet arrival windowing may be defined as the interval between two consecutive ‘n’ moments (e.g., between n₂ and n₃, between n₃ and n₄, and so on). The windowing size may be N₀. All packets that become available for transmission in a given packet arrival window may be expected to be transmitted on sidelink resources that follow that packet arrival window. As shown in FIG. 4, n′₁, n′₂, n′₃, . . . are fixed points in time (e.g., slot #100, slot #300, and so on), and resource selection window Wₖ₊₁ may be for packet arriving in [n′ₖ, n′ₖ₊₁]. The requirement may be that (N₀+Z) is less than a remaining PDB with Z denoting a number of candidate slots, and N₀ may be preconfigured based on a minimum expected packet latency.

Accordingly, under various proposed schemes in accordance with the present disclosure, a UE (e.g., UE 110) may communicate with one or more UEs (e.g., at least UE 120) on sidelink resources (e.g., time and/or frequency resources) and perform sensing on a set of resources with respect to a sidelink. The UE may select one or more resources for transmission from a predefined resource selection window, and the UE may transmit one or more transmission blocks (TBs) on the selected resource(s). The time position of the sensed set of resources may be determined in relation to the time position of the resource selection window. The transmitted TB(s) may be part of an aperiodic traffic. The sensing on the sidelink may allow the UE to detect one or more resource reservations (made by other UE(s)) for periodic traffic(s). The predefined resource selection window may be fixed prior to packet arrival or, alternatively, may be dynamically determined. In some implementations, a size of the predefined resource selection window may be fully adaptable.

Illustrative Implementations

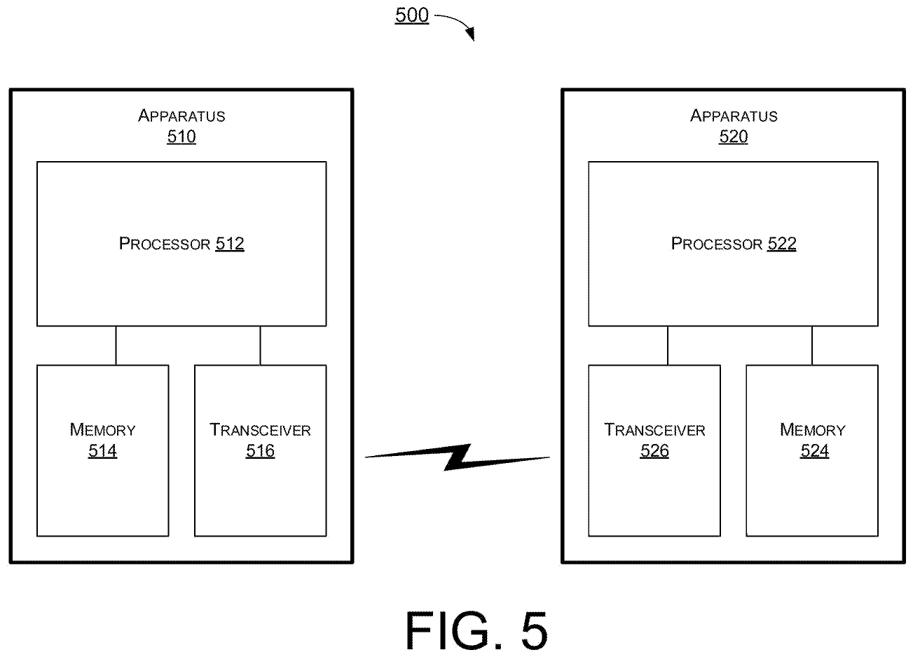

FIG. 5 illustrates an example communication system 500 having an example apparatus 510 and an example apparatus 520 in accordance with an implementation of the present disclosure. Each of apparatus 510 and apparatus 520 may perform various functions to implement schemes, techniques, processes and methods described herein pertaining to sidelink resource selection based on a predefined set for V2X in 5G NR mobile communications, including various schemes described above as well as processes described below.

Each of apparatus 510 and apparatus 520 may be a part of an electronic apparatus, which may be a UE such as a vehicle, a portable or mobile apparatus, a wearable apparatus, a wireless communication apparatus or a computing apparatus. For instance, each of apparatus 510 and apparatus 520 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT or NB-IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. Alternatively, each of apparatus 510 and apparatus 520 may be implemented in the form of one or more integrated-circuit (IC) chips such as, for example and without limitation, one or more single-core processors, one or more multi-core processors, or one or more complex-instruction-set-computing (CISC) processors. Each of apparatus 510 and apparatus 520 may include at least some of those components shown in FIG. 5 such as a processor 512 and a processor 522, respectively. Each of apparatus 510 and apparatus 520 may further include one or more other components not pertinent to the proposed scheme of the present disclosure (e.g., internal power supply, display device and/or user interface device), and, thus, such component(s) of each of apparatus 510 and apparatus 520 are neither shown in FIG. 5 nor described below in the interest of simplicity and brevity.

In some implementations, at least one of apparatus 510 and apparatus 520 may be a part of an electronic apparatus, which may be a vehicle, a roadside unit (RSU), network node or base station (e.g., eNB, gNB or TRP), a small cell, a router or a gateway. For instance, at least one of apparatus 510 and apparatus 520 may be implemented in a vehicle in a V2V or V2X network, an eNodeB in an LTE, LTE-Advanced or LTE-Advanced Pro network or in a gNB in a 5G, NR, IoT or NB-IoT network. Alternatively, at least one of apparatus 510 and apparatus 520 may be implemented in the form of one or more IC chips such as, for example and without limitation, one or more single-core processors, one or more multi-core processors, or one or more CISC processors.

In one aspect, each of processor 512 and processor 522 may be implemented in the form of one or more single-core processors, one or more multi-core processors, or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including sidelink resource selection based on a predefined set for V2X in 5G NR mobile communications in accordance with various implementations of the present disclosure.

In some implementations, apparatus 510 may also include a transceiver 516, as a communication device, coupled to processor 512 and capable of wirelessly transmitting and receiving data. In some implementations, apparatus 510 may further include a memory 514 coupled to processor 512 and capable of being accessed by processor 512 and storing data therein. In some implementations, apparatus 520 may also include a transceiver 526, as a communication device, coupled to processor 522 and capable of wirelessly transmitting and receiving data. In some implementations, apparatus 520 may further include a memory 524 coupled to processor 522 and capable of being accessed by processor 522 and storing data therein. Accordingly, apparatus 510 and apparatus 520 may wirelessly communicate with each other via transceiver 516 and transceiver 526, respectively.

To aid better understanding, the following description of the operations, functionalities and capabilities of each of apparatus 510 and apparatus 520 is provided in the context of an NR V2X communication environment in which apparatus 510 is implemented in or as a wireless communication device, a communication apparatus or a UE (e.g., first UE 110) and apparatus 520 is implemented in or as another wireless communication device, another communication apparatus or another UE (e.g., second UE 120).

In one aspect of sidelink resource selection based on a predefined set for V2X in 5G NR mobile communications in accordance with the present disclosure, processor 512 of apparatus 510, implemented in a UE (e.g., first UE 110), may perform, via transceiver 516, a first type of sensing on a sidelink during a first sensing window to select first resources from a first set of candidate resources within a selection window. Additionally, processor 512 may perform, via transceiver 516, a second type of sensing on the sidelink during a second sensing window to select second resources from a second set of candidate resources within the selection window. The first type of sensing and the second type of sensing may be different from each other. The second set of candidate resources may at least partially overlap with the first set of candidate resources. Moreover, processor 512 may communicate, via transceiver 516, with another UE (e.g., apparatus 520 as second UE 120) on the sidelink using at least the selected second resources from the second set of candidate resources.

In some implementations, the second type of sensing may involve detecting one or more aperiodic reservations by one or more other UEs in a sidelink resource pool. In some implementations, the second type of sensing may include CPS.

In some implementations, the first type of sensing may involve detecting one or more periodic reservations by one or more other UEs in a sidelink resource pool. In some implementations, the first type of sensing may include PBPS.

In some implementations, the second set of candidate resources may be defined as a subset of the first set of candidate resources. In some implementations, the second set of candidate resources may include a predefined set of time-domain resources or window.

In some implementations, processor 512 may perform additional operations. For instance, processor 512 may receive, via transceiver 516, a pre-configuration from a wireless network (e.g., from wireless network 130 via network node 135). Moreover, processor 512 may determine a size of the predefined set of time-domain resources or window.

In some implementations, the size of the set of time-domain resources may be lower-bound by a minimum value based on the pre-configuration. Additionally, or alternatively, the size of the set of time-domain resources may be upper-bound by a maximum value based on the pre-configuration.

Illustrative Processes

FIG. 6 illustrates an example process 600 in accordance with an implementation of the present disclosure. Process 600 may be an example implementation of the proposed schemes described above with respect to sidelink resource selection based on a predefined set for V2X in 5G NR mobile communications in accordance with the present disclosure. Process 600 may represent an aspect of implementation of features of apparatus 510 and apparatus 520. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may also be repeated partially or entirely. Process 600 may be implemented by apparatus 510, apparatus 520 and/or any suitable wireless communication device, UE, RSU, base station or machine type devices. Solely for illustrative purposes and without limitation, process 600 is described below in the context of apparatus 510 as a UE (e.g., first UE 110) and apparatus 520 as a network node (e.g., base station 135 of wireless network 130). Process 600 may begin at block 610.

At 610, process 600 may involve processor 512 of apparatus 510, implemented in a UE (e.g., first UE 110), performing, via transceiver 516, a first type of sensing on a sidelink during a first sensing window to select first resources from a first set of candidate resources within a selection window. Process 600 may proceed from 610 to 620.

At 620, process 600 may involve processor 512 performing, via transceiver 516, a second type of sensing on the sidelink during a second sensing window to select second resources from a second set of candidate resources within the selection window. The first type of sensing and the second type of sensing may be different from each other. The second set of candidate resources may at least partially overlap with the first set of candidate resources. Process 600 may proceed from 620 to 630.

At 630, process 600 may involve processor 512 communicating, via transceiver 516, with another UE (e.g., apparatus 520 as second UE 120) on the sidelink using at least the selected second resources from the second set of candidate resources.

In some implementations, the second type of sensing may involve detecting one or more aperiodic reservations by one or more other UEs in a sidelink resource pool. In some implementations, the second type of sensing may include CPS.

In some implementations, the first type of sensing may involve detecting one or more periodic reservations by one or more other UEs in a sidelink resource pool. In some implementations, the first type of sensing may include PBPS.

In some implementations, the second set of candidate resources may be defined as a subset of the first set of candidate resources. In some implementations, the second set of candidate resources may include a predefined set of time-domain resources or window.

In some implementations, process 600 may further involve processor 512 performing additional operations. For instance, process 600 may involve processor 512 receiving, via transceiver 516, a pre-configuration from a wireless network (e.g., from wireless network 130 via network node 135). Moreover, process 600 may involve processor 512 determining a size of the predefined set of time-domain resources or window.

In some implementations, the size of the set of time-domain resources may be lower-bound by a minimum value based on the pre-configuration. Additionally, or alternatively, the size of the set of time-domain resources may be upper-bound by a maximum value based on the pre-configuration.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method of sidelink communication, comprising:
performing, by a processor of an apparatus implemented in a first user equipment (UE), a first type of sensing on a sidelink during a first sensing window to select first resources from a first set of candidate resources within a selection window;
performing, by the processor, a second type of sensing on the sidelink during a second sensing window to select second resources from a second set of candidate resources within the selection window; and
communicating, by the processor, with another UE on the sidelink using at least the selected second resources from the second set of candidate resources,
wherein the first type of sensing and the second type of sensing are different, and
wherein the second set of candidate resources at least partially overlaps with the first set of candidate resources.

2. The method of claim 1, wherein the second type of sensing involves detecting one or more aperiodic reservations by one or more other UEs in a sidelink resource pool.

3. The method of claim 2, wherein the second type of sensing comprises contiguous partial sensing (CPS).

4. The method of claim 1, wherein the first type of sensing involves detecting one or more periodic reservations by one or more other UEs in a sidelink resource pool.

5. The method of claim 4, wherein the first type of sensing comprises periodic-based partial sensing (PBPS).

6. The method of claim 1, wherein the second set of candidate resources is defined as a subset of the first set of candidate resources.

7. The method of claim 6, wherein the second set of candidate resources comprise a predefined set of time-domain resources or window.

8. The method of claim 7, further comprising:
receiving, by the processor, a pre-configuration from a wireless network; and
determining, by the processor, a size of the predefined set of time-domain resources or window.

9. The method of claim 8, wherein the size of the predefined set of time-domain resources is lower-bound by a minimum value based on the pre-configuration.

10. The method of claim 8, wherein the size of the predefined set of time-domain resources is upper-bound by a maximum value based on the pre-configuration.

11. An apparatus implementable in a user equipment (UE), comprising:
a transceiver configured to communicate wirelessly with one or more other UEs and a network node of a wireless network; and
a processor coupled to the transceiver and configured to perform operations comprising:
performing, via the transceiver, a first type of sensing on a sidelink during a first sensing window to select first resources from a first set of candidate resources within a selection window;
performing, via the transceiver, a second type of sensing on the sidelink during a second sensing window to select second resources from a second set of candidate resources within the selection window; and
communicating, via the transceiver, with one of the one or more UEs on the sidelink using at least the selected second resources form the second set of candidate resources,
wherein the first type of sensing and the second type of sensing are different, and
wherein the second set of candidate resources at least partially overlaps with the first set of candidate resources.

12. The apparatus of claim 11, wherein the second type of sensing involves detecting one or more aperiodic reservations by one or more other UEs in a sidelink resource pool.

13. The apparatus of claim 12, wherein the second type of sensing comprises contiguous partial sensing (CPS).

14. The apparatus of claim 11, wherein the first type of sensing involves detecting one or more periodic reservations by one or more other UEs in a sidelink resource pool.

15. The apparatus of claim 14, wherein the first type of sensing comprises periodic-based partial sensing (PBPS).

16. The apparatus of claim 11, wherein the second set of candidate resources is defined as a subset of the first set of candidate resources.

17. The apparatus of claim 16, wherein the second set of candidate resources comprises a predefined set of time-domain resources or window.

18. The apparatus of claim 17, wherein the processor is further configured to perform operations comprising:
receiving, via the transceiver, a pre-configuration from a wireless network; and
determining a size of the predefined set of time-domain resources or window.

19. The apparatus of claim 18, wherein the size of the predefined set of time-domain resources is lower-bound by a minimum value based on the pre-configuration.

20. The apparatus of claim 18, wherein the size of the predefined set of time-domain resources is upper-bound by a maximum value based on the pre-configuration.
